(19) United States
(12) Patent Application Publication
(10) Pub. No.: US 2004/0215648 A1
(43) Pub. Date: Oct. 28, 2004

(54) System, method and computer program product for identifying and displaying inter-relationships between corporate directors and boards

(75) Inventors: Ric Marshall, Portland, ME (US); Jacqueline Cook, Seattle, WA (US)

Correspondence Address: STERNE, KESSLER, GOLDSTEIN & FOX PLLC, 1100 NEW YORK AVENUE, N.W., WASHINGTON, DC, 20005, US

(73) Assignee: The Corporate Library

(21) Appl. No.: 10/408,277

(22) Filed: Apr. 8, 2003

(51) Int. Cl. G06F 7/00

(52) U.S. Cl. 707/102

(57) ABSTRACT

A system, method and computer program product for identifying and displaying inter-relationships between corporate directors and boards is provided. The system includes a user interface that permits a user to select a query entity, which can include a director or corporation and an application program that accesses a relational database to identify interlinks between the query entity and other entities. Where the query entity is a director, interlinks can be identified based on membership on a common board of directors or an affiliation with a common non-corporate organization, and where the query entity is a corporation, interlinks can be identified based on sharing a common director. Where two entities share two or more interlinks, an “interlock” is identified, which signifies a relationship of mutual self-interest or potential conflicts-of-interest that may adversely impact corporate governance. Results are displayed to a user via a graphical or tabular display interface.

### BACKGROUND OF THE INVENTION

1. Field of the Invention

The present invention generally relates to tools for the research and analysis of business organizations. More particularly, the present invention relates to computer-based tools for the research and analysis of business organizations, such as publicly-traded corporations.

2. Background

Recent scandals and stock market losses arising from corporate malfeasance serve as a grave reminder of the importance of independent oversight by the board of directors of a company. It has been observed that complex inter-relationships exist between the directors of America's largest corporations. These inter-relationships can arise from the fact that directors sit on one or more corporate boards together, or may be based on joint participation in other organizations, such as non-profit, professional, or academic organizations. In many cases, these relationships can be constructive and beneficial. In other cases, however, these relationships can interfere with the fiduciary obligations directors have to protect the interests of the shareholders.

In order to properly evaluate the effect that such relationships have on a given company or on an industry as a whole, one must first be able to identify them. Often, the information necessary to establish a link between a corporate director and another director or board may be mined from publicly-available sources, such as filings with the Securities and Exchange Commission (SEC), news stories, or company web-sites. Using this information, the interconnections may be identified and mapped out manually on a case-by-case basis. However, when the number of interconnects is large, this becomes an extremely arduous task. Moreover, this arduous task must be repeated each time information is sought for a new corporate director or board.

Few automated tools exist for identifying and displaying inter-relationships that exist between corporate directors and/or boards. One tool that is currently available on the World Wide Web (located at the domain name http://www.theyrule.net) permits a user to build and view a map of interconnections between directors on the boards of selected publicly-traded corporations. However, this tool provides only limited functionality. For example, the user is required to build each map one connection at a time by selecting a director, determining if the selected director sits on the board of one of the other company or companies, and then generating a link to the other company or companies. Because these steps must be repeated to generate each connection, the overall process is labor-intensive and time-consuming. Also, the user is required to follow a hypothesis in order to locate a specific director or company in a network.

The tool is also lacking in that it does not identify important features of board and director networks, such as relationships in which two or more directors sit on two or more of the same corporate boards, such that the mutual self-interest ofthe directors may conflict with shareholder interests. Furthermore, the tool can only link directors by identifying the boards on which they sit, and does not account for other affiliations that may foster inter-relationships, such as participation in non-profit, professional or academic organizations. Finally, the tool is lacking in that it provides only a limited workspace within which to build maps, thereby limiting the number of connections that may be displayed.

What is desired then is a tool for identifying and displaying inter-relationships between a given director or board of a company and other directors and boards in a quick and easy manner. The desired tool should permit a user to identify multiple levels of interconnections between a director or board and other directors and boards, while displaying the results in a form that is easy to view and understand. Additionally, the desired tool should recognize inter-relationships based on board membership as well as on other non-corporate affiliations such as membership in non-profit, professional, and academic organizations. Furthermore, the desired tool should be easily accessible, user friendly, and scaleable to accommodate any number of users and any amount of corporate and director-related data.

### BRIEF SUMMARY OF THE INVENTION

The present invention is directed to a unique and powerful tool that applies network theory to the research and analysis of inter-relationships between corporate directors and boards. Embodiments of the present invention facilitate research into the previously unexplored formal and informal networks that connect otherwise unrelated companies, and in particular highlight “interlocks” situations in which two or more directors sit on the same two or more boards-that currently exist between many corporate boards.

Embodiments of the present invention facilitate the automated research and analysis of complex relationships between corporate directors and boards in a manner that is significantly faster than known prior art techniques. In accordance with embodiments of the invention, a user simply selects a director or board of interest, and multiple levels of interconnections between the selected director or board and other directors and boards are automatically identified and displayed in a format that is both easy to view and understand. Furthermore, inter-relationships based on board membership as well as on other non-corporate affiliations can be identified.

In particular, as will be described in more detail herein, the present invention provides a system, method and computer program product for identifying and displaying inter-relationships between corporate directors and boards. In accordance with an embodiment of the invention, a query director is selected and a database is searched to identify corporations having a board upon which the query director sits. The database is then searched to identify directors having first degree interlinks to the query director, wherein each director having a first degree interlink sits on a board of one or more of the identified corporations. Interlocks arising from the first degree interlinks are also identified, wherein an interlock is identified where a director having a first degree interlink sits on a board of two or more of the identified corporations. The first degree interlinks and interlocks are then displayed to the user.

In accordance with a further embodiment ofthe present invention, a query corporation is selected and a database is searched to identify directors that sit on a board of directors of the query corporation. The database is then searched to identify corporations having first degree interlinks to the query corporation, wherein each corporation having a first degree interlink has a board that includes one or more of the identified directors. Interlocks arising from the first degree interlinks are also identified, wherein an interlock is identified where a corporation having a first degree interlink has a board of directors that includes two or more of the identified directors. The first degree interlinks and interlocks arising therefrom are then displayed to the user.

In accordance with an additional embodiment of the present invention, second degree interlinks are also identified, wherein identifying second degree interlinks comprises searching the database to identify entities having interlinks to the entities having first degree interlinks. Interlocks arising from the second degree interlinks are then identified, wherein an interlock is identified where an entity has two or more interlinks to an entity having first degree interlinks. The second degree interlinks and interlocks arising therefrom are then displayed to the user. In accordance with further embodiments of the present invention, additional degrees of interlinks and interlocks arising therefrom may be identified and displayed to the user. Additionally, interlinks and interlocks based on non-corporate affiliations may also be identified and displayed to the user.

In an embodiment of the present invention, a user interface is also provided that is easily accessible and user friendly. A system in accordance with an embodiment of the present invention is also scaleable to accommodate any number of users and any amount of corporate and director-related data.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 depicts an example environment in which an embodiment of the present invention may operate.

FIG. 2 is a high level block diagram depicting client and server-side components of a system for identifying and displaying inter-relationships between corporate directors and boards in accordance with an embodiment of the present invention.

FIG. 3 depicts a flowchart of a method for identifying and displaying inter-relationships between corporate directors and boards in accordance with an embodiment of the present invention.

FIG. 4 illustrates a network of directors including a query entity, first degree interlinks, second degree interlinks, and interlocks resulting therefrom in accordance with an embodiment of the present invention.

FIG. 5 illustrates a network of companies including a query entity, first degree interlinks, second degree interlinks, and interlocks resulting therefrom in accordance with an embodiment of the present invention.

FIGS. 6 and 7 illustrate example graphic display interfaces for displaying results of a method for identifying inter-relationships between corporate directors and boards in accordance with an embodiment of the present invention.

FIG. 8 illustrates an example computer system for identifying and displaying inter-relationships between corporate directors and boards in accordance with embodiments of the present invention

The features and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF THE INVENTION

A. Overview

The present invention is directed to a system, method and computer program product for identifying and displaying inter-relationships between corporate directors and boards. The system includes a user interface that permits a user to select a query entity, which can include a director or corporation and an application program that accesses a relational database to identify interlinks between the query entity and other entities. Where the query entity is a director, interlinks can be identified based on membership on a common board of directors or an affiliation with a common non-corporate organization, and where the query entity is a corporation, interlinks can be identified based on sharing a common director. Where two entities share two or more interlinks, an “interlock” is identified, which signifies a relationship in which there exists the potential for mutual self-interest, possibly entailing a conflict with shareholder interests, thereby adversely impacting on corporate governance. Results are displayed to a user via a graphical or tabular display interface.

B. Example Operating Environment in Accordance with Embodiments of the Present Invention

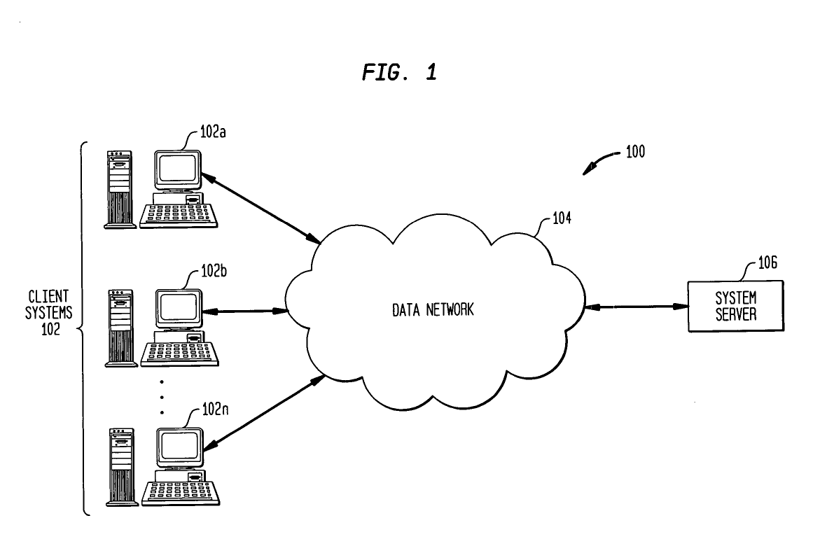

FIG. 1 depicts an example environment 100 in which embodiments of the present invention may operate. It should be understood that example operating environment 100 is shown for illustrative purposes only and does not limit the present invention. Other implementations of example operating environment 100 will be apparent to persons skilled in the relevant art(s) based on the teachings contained herein, and the invention is directed to such other implementations.

As shown in FIG. 1, example environment 100 includes a data network 104 that communicatively connects a plurality of client systems 102 to a server system 106. Data network 104 provides a pathway for the bi-directional communication of electronic data between client systems 102 and server system 106. Data network 104 may comprise any type of computer network or combination of networks including, but not limited to, circuit switched and/or packet switched networks. Additionally, data network 104 may comprise a variety of transmission mediums including, but not limited to, twisted pair, coaxial cable, fiber-optic and/or wireless transmission mediums. In an example environment, data network 104 comprises a local area network (LAN). In an alternate example environment, data network 104 includes a wide area network (WAN) such as the Internet.

Example environment 100 may include any number of client systems 102a through 102n. As will be described in more detail below, each client system 102 is configured to perform user interface functions for carrying out the features of the present invention. For example, in accordance with an embodiment of the invention, each client system 102 is configured to accept required user input and transmit it to server system 106, and to display corresponding results information received from server system 106. In an embodiment, each client system 102 comprises a personal computer (PC)-based system. However, this example is not limiting and client system 102 may comprise other devices or systems capable of transmitting and receiving electronic information over a data network including, but not limited to, data terminal equipment, set-top boxes, Personal Digital Assistants (PDAs), wireless handheld devices, cellular phones and the like.

As will also be discussed in more detail below, server system 106 is configured to perform necessary user interface, data processing, and database access functions for carrying out the features of the present invention. For example, in accordance with an embodiment of the invention, server system 106 is configured to accept required user input from a client system 102, access and process data stored in a database in accordance with the user input to generate results therefrom, and send those results to the client system 102.

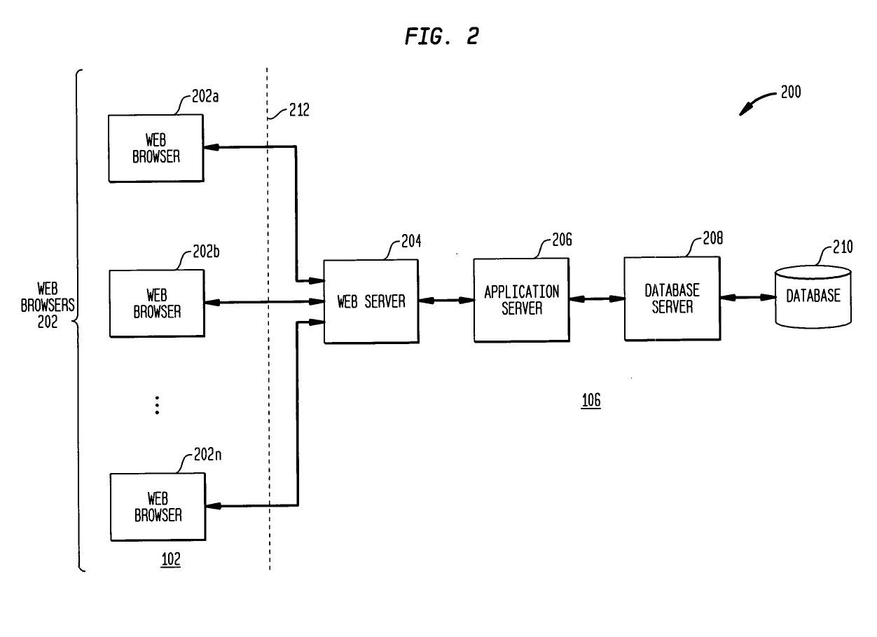

FIG. 2 is a high level block diagram 200 depicting client and server-side components of a system for identifying and displaying inter-relationships between corporate directors and boards in accordance with an embodiment of the present invention. For the sake of clarity, FIG. 2 is divided into client-side components, which are found to the left of an imaginary line 212, and server-side components, which are found to the right of imaginary line 212.

The client-side components comprise one or more web browsers 202, each of which is executed by, and comprises part of, a corresponding client system 102. Web browsers 202 interact with web server 204 to perform user interface functions for carrying out the features of the present invention. For example, in accordance with an embodiment of the present invention, each web browser 202 accepts required user input and sends it to web server 204, and displays results information received from web server 204. In an embodiment, web browser 202 comprises Microsoft Internet Explorer™, published by Microsoft Corporation of Redmond, Wash. However, the invention is not so limited, and other web browsers may be used.

The server-side components include a web server 204, an application server 206, a database server 208 and a database 210. Web server 204 comprises software that presents a web interface, which may comprise one or more web pages, to users of client systems 102 via a corresponding web browser 202. This web interface facilitates the transfer of electronic data between client systems 102 and server system 106. In an embodiment, web server 204 comprises Microsoft Internet Information Server (IIS)® Web server software, published by Microsoft Corporation of Redmond, Wash. However, the invention is not so limited and other web server software may be used.

Application server 206 comprises software that receives user input via web server 204 and, in accordance with the user input, accesses and processes selected data stored in database 210 to generate results therefrom. The application server 206 caches the results locally and also sends the results back to the web browser 202 via web server 204 for display to the user.

Database 210 comprises a collection of data that is organized so that its contents can easily be accessed, managed and updated. In an embodiment, database 210 comprises a relational database. However, the invention is not so limited, and database 210 may comprise any type of database including but not limited to an Extensible Markup Language (XML) database or an object-oriented programming database.

Database 210 is accessed via database server 208. In an embodiment, database server 208 comprises software for accessing database 210 using Structured Query Language (SQL), such as Microsoft SQL Server™, published by Microsoft Corporation of Redmond, Wash., or Sybase SQL Anywhere®, published by Sybase Inc. of Dublin, Canada, although the invention is not so limited.

The above-described server-side components may be implemented on one or more computers. In an embodiment of the invention, web server 204, application server 206, and database server 208 are each implemented on separate computers. For example, in an embodiment, web server 204, application server 206 and database server 208 are each implemented on a separate Linux®-based or Microsoft Windows®-based computer. In accordance with such an embodiment, database 210 may be stored in a memory internal to the computer on which database server 208 resides. Alternately, database 210 may be stored externally with respect to the computer on which database server 208 resides.

The use of separate computers to implement server system 106 provides for enhanced system scaleability. For example, to accommodate an increased number of users, web server 204 may be implemented on a more powerful computer, or multiple instances of web server 204 may be implemented on multiple computers, with minimal impact to the implementation of application server 206 or database server 208. Likewise, to increase overall data processing speed, application server 206 may be implemented on a more powerful computer, or multiple instances of application server 206 may be implemented on multiple computers, with minimal impact to the implementation of web server 204 or database server 208. Additionally, to accommodate more data, database 210 may be stored in a larger memory or across multiple memories, and database server 208 may be implemented on a more powerful computer, or multiple instances of database server 208 may be implemented on multiple computers, with minimal impact to the implementation of web server 204 or application server 206.

C. Method for Identifying and Displaying Inter-relationships Between Corporate Directors and Boards in Accordance with Embodiments of the Present Invention

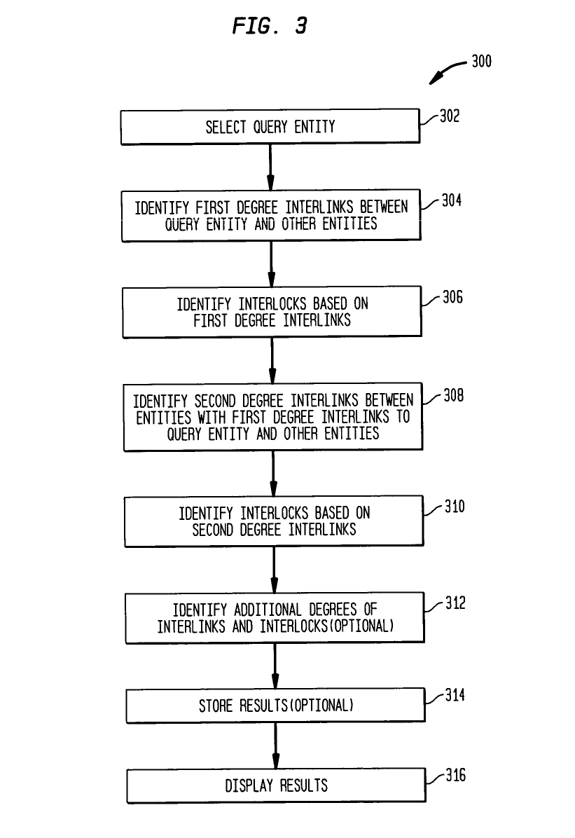

FIG. 3 depicts a flowchart 300 of a method for identifying and displaying inter-relationships between corporate directors and boards in accordance with an embodiment of the present invention. The invention, however, is not limited to the description provided by the flowchart 300. Rather, it will be apparent to persons skilled in the art from the teachings provided herein that other functional flows are within the scope and spirit of the present invention. For example, the present invention encompasses the performance of additional steps or fewer steps than those shown in flowchart 300, as well as the performance of steps in an order different than that depicted in flowchart 300.

The method of flowchart 300 begins at step 302, in which a user selects a query entity. In an embodiment, the query entity may comprise either a director of a company or a company. In accordance with the example operating environment described above in reference to FIGS. 1 and 2, the user selects the query entity by providing input to a web interface displayed by web browser 202. For example, the query entity may be identified by typing the name of the entity in a designated text box or by selecting the entity from a pre-defined list of available entities displayed on the web interface. This information is then transmitted to web server 204, which transfers it to application server 206 for processing.

At step 304, first degree interlinks between the query entity and other entities are identified. As used herein, the term “interlink” refers to any common feature or attribute that may be perceived as connecting one entity with another. For example, where the entity is a director, an interlink to another director may be identified by virtue of the fact that both directors sit on the board of the same company. Where the query entity is a company, an interlink to another company may be identified by virtue of the fact that both companies share a common director. However, these examples are not limiting, and other common features or attributes may be used to identify interlinks between directors, companies, and other entities in accordance with embodiments of the present invention.

A “first degree” interlink refers to an interlink between the query entity and another entity. With respect to the example operating environment described above in reference to FIGS. 1 and 2, application server 206 performs the task of identifying first degree interlinks by accessing database server 208 to search database 210 for the query entity and, once the query entity has been located, to identify additional entities in database 210 that share a common feature or attribute with the query entity. For example, in an embodiment in which the query entity is a director, application server 206 accesses database server 208 to search database 210 for the director and, when the director has been located, to identify other directors in database 210 that share a common feature or attribute with the director, such as membership on a common board. As a further example, in an embodiment in which the query entity is a company, application server 206 accesses database server 208 to search database 210 for the company and, when the company has been located, to identify other companies in database 210 that share a common feature or attribute with the company, such as sharing a common director.

However, in accordance with embodiments of the present invention, the common feature or attribute that may be used to identify interlinks is not limited to membership on a given board of directors or employment of a given director. Rather, other common features or attributes may also be used including, but not limited to, participation in certain professional, non-profit, or academic organizations via membership, contributions, meeting attendance, or some other form of affiliation, that may, under certain circumstances, be interpreted as implying face-to-face contact or a shared set of values and interests. The only requirement in this regard is that database 210 store the appropriate features or attributes in relation to each entity, such that common features or attributes between entities can be identified by database server 208. By storing these additional features or attributes, an embodiment of the present invention can advantageously be used to identify inter-relationships based on informal networks existing outside the boardroom that link corporations and directors.

At step 306, interlocks based on the first degree interlinks are identified. As used herein, the term “interlock” generally refers to a relationship in which two entities share two or more interlinks. For example, in an embodiment in which the entities are directors and an interlink is based on membership on the same board, an interlock occurs when two or more directors sit on two or more of the same boards. As a further example, in an embodiment in which the entities are companies and an interlock is based on sharing a common director, an interlock occurs when two or more companies share two or more directors. Both of these types of interlocks are of particular significance because they indicate a relationship of mutual self-interest or potential conflicts-of-interest that may adversely impact corporate governance of both organizations. In accordance with the example operating environment described above, the identification of interlocks based on first degree interlinks is performed by application server 206.

At step 308, second degree interlinks between the entities identified in step 304 and other entities are identified. A “second degree” interlink refers to an interlink between an entity having a first degree interlink to the query entity and another entity. So, for example, a second degree interlink would exist between a director D1, who sits on a board with a query director, and another director D2, who sits on a different board with director D1. Likewise, a second degree interlink would exist between a company C1, which shares a director with a query company, and a company C2, which shares a different director with company C1. With respect to the example operating environment described above, application server 206 performs the task of identifying second degree interlinks by accessing database server 208 to search database 210 for the entities identified in step 304 and, once those entities have been located, to identify additional entities in database 210 that share a common feature or attribute with those entities.

At step 310, interlocks based on the second degree interlinks are identified. In accordance with the example operating environment described above, the identification of interlocks based on second degree interlinks is performed by application server 206.

At optional step 312, additional degrees of interlinks and interlocks are identified. In accordance with this step, any additional number of degrees of interlinks from 3 to n may be identified, where an interlink of n degrees comprises an interlink between an entity having an n-i degree interlink to the query entity and other entities. After each additional degree of interlinks has been identified, interlocks resulting therefrom may also be identified. Note, however, that limiting the number of degrees of interlinks identified may be desirable in order to conserve system resources and simplify results presentation. In an embodiment, step 312 is performed by application server 206 in conjunction with database server 208 and database 210.

At optional step 314, the results of the above-described steps are stored in memory, wherein the results that are stored preferably include each of the entities identified, the common features or attributes giving rise to interlinks between them, the degree of each interlink, and the presence of interlocks. Results storage may be desirable for a number of reasons, including ensuring that data is not lost, to permit the same set of results to be accessed several times by the same or different users, or to permit the same set of results to be displayed to a user in a variety of different formats. In accordance with the example operating environment described above in reference to FIGS. 1 and 2, the results of the above-described steps are stored in memory by application server 206, wherein the memory may be internal or external to the computer on which application server 206 resides.

At step 316, the results of the above-described steps are displayed to the user. Results may be displayed in a variety of formats, including in a graphical format, such as a graphical mapping of entities and the interlinks and interlocks that connect them, as well as in a tabular or list-based format. In an embodiment, the results are incorporated into a web interface and provided by web server 204 to web browser 202. The manner in which the results are displayed to the user will be discussed in more detail below.

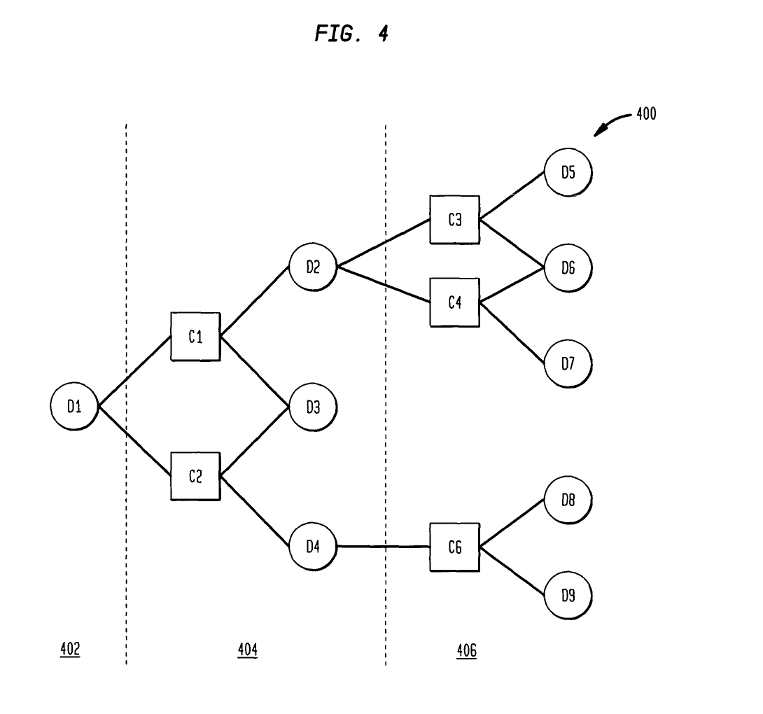

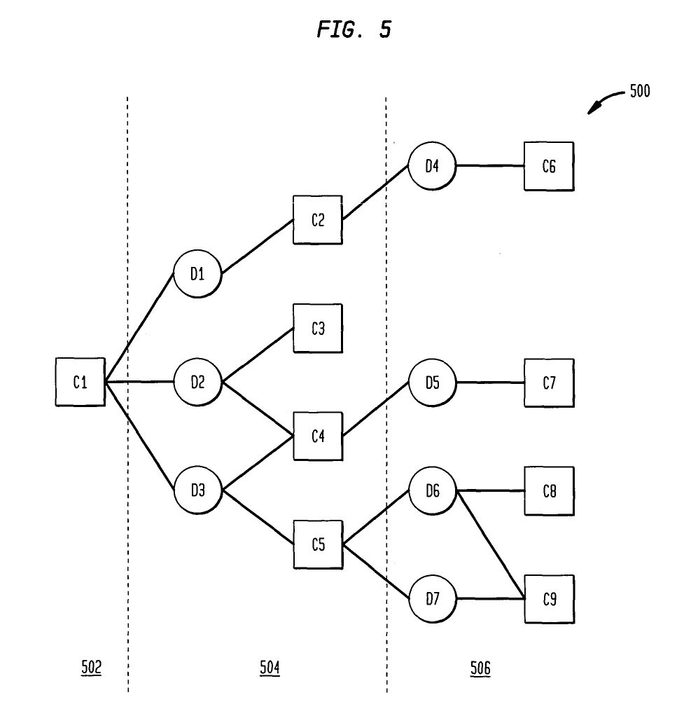

In order to facilitate a better understanding ofthe present invention, FIGS. 4 and 5 are provided to further illustrate the concept of first and second degree interlinks and interlocks resulting therefrom. FIG. 4 illustrates a network 400 comprising a query entity 402, a set of first degree interlinks 404, and a set of second degree interlinks 406. As shown in FIG. 4, the query entity 402 is a director D1 who sits on the board of directors of companies C1 and C2. Because directors D2 and D3 also sit on the board of directors of company C1, they have first degree interlinks to director D1. Similarly, because directors D3 and D4 sit on the board of directors of company C2, they also have first degree interlinks to director D1.

The first degree interlinks 404 also result in an interlock. In particular, there is an interlock between director D1 and director D3 because they share two interlinks with each other: a first interlink by virtue of the fact that both directors sit on the board of company C1 and a second interlink by virtue of the fact that both directors sit on the board of company C2.

Directors D2 and D4 are also linked to other directors by a number of second degree-interlinks 406. For example, because directors D5 and D6 sit on the board of directors of company C3 with director D2, they have second degree interlinks to director D2. Similarly, because directors D8 and D9 sit on the board of directors of company C6 with director D4, they have second degree interlinks to director D4.

The second degree interlinks 406 result in a further interlock. In particular, there is an interlock between director D2 and director D6 because they share two interlinks with each other: a first interlink by virtue of the fact that both directors sit on the board of company C3 and a second interlink by virtue of the fact that both directors sit on the board of company C4.

FIG. 5 illustrates a network 500 comprising a query entity 502, a set of first degree interlinks 504, and a set of second degree interlinks 506. As shown in FIG. 5, the query entity 502 is a company C1 having a board of directors that includes directors D1, D2 and D3. Because company C2 has a board that also includes director D1, it has a first degree interlink to company C1. Similarly, because companies C3 and C4 have boards that include director D2 and companies C4 and C5 have boards that include director D3, they also have first degree interlinks to company C1.

The first degree interlinks 504 also result in an interlock. In particular, there is an interlock between company C1 and company C4 because they share two interlinks with each other: a first interlink by virtue of the fact that both companies share a common director D2 and a second interlink by virtue of the fact that both companies share a common director D3.

Companies C2, C4 and C5 are also linked to other companies by a number of second degree interlinks 506. For example, because company C6 shares a common director D4 with company C2, company C6 has a second degree interlink to company C2. Similarly, because company C7 shares a common director D5 with company C4, company C7 has a second degree interlink with company C4. Finally, because companies C8 and C9 share common directors (D6 and D7, respectively) with company C5, companies C8 and C9 have a second degree interlink to company C5.

The second degree interlinks 506 result in a further interlock. In particular, there is an interlock between company C5 and company C9 because they share two interlinks with each other: a first interlink by virtue of the fact that both companies share a common director D6 and a second interlink by virtue of the fact that both companies share a common director D7.

D. Example Display Interface in Accordance with Embodiments of the Present Invention

As described above, the results of a method in accordance with embodiments of the present invention may be displayed in a variety of formats, including graphical and tabular formats. In an embodiment in which results are displayed via a web interface, results may be displayed in a graphical format using Macromedia Flash™ software published by Macromedia Inc. of San Francisco, Calif., or in a tabular or list-based format using an Active Server Page (ASP), which is a feature of Microsoft Internet Information Server (IIS)® Web server software, published by Microsoft Corporation of Redmond, Wash. However, the invention is not so limited, and other display methods may be used.

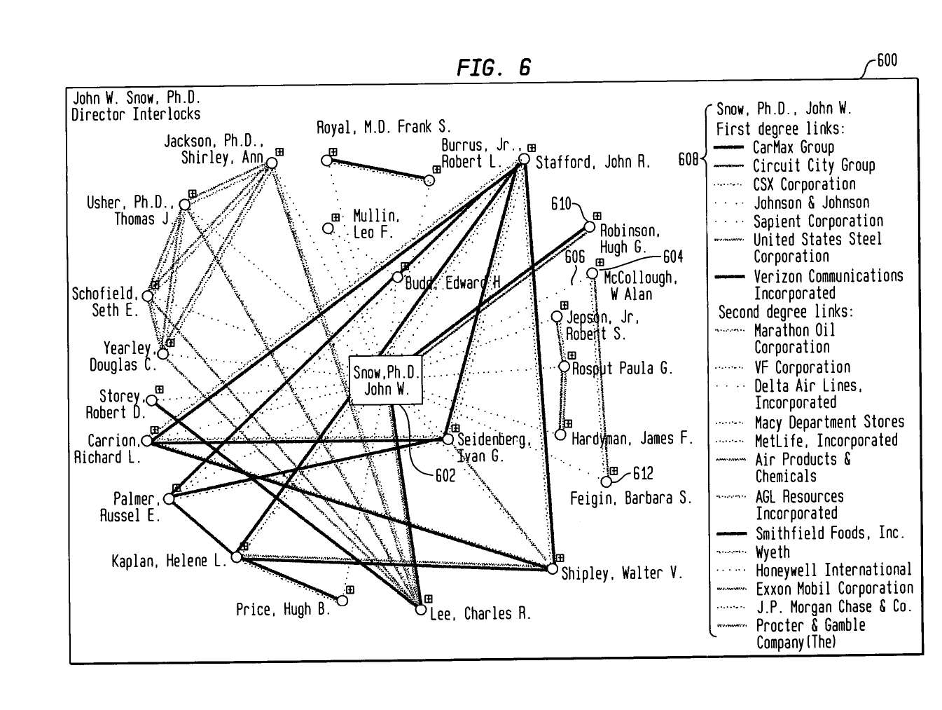

FIG. 6 illustrates an example display interface 600 for displaying results in a graphical format in accordance with an embodiment of the present invention. An interface such as display interface 600 may be used, for example, in an embodiment in which the query entity is a director, first degree interlinks and second degree interlinks to other directors are identified, and the interlinks are based on common membership on the board of directors of a given company.

As shown in FIG. 6, the query entity is represented as a box 602 located near the center of the display interface 600, wherein the box 602 includes the name of the query director. Directors connected to the query director via first degree and second degree interlinks are represented as dots labeled with corresponding director names, such as exemplary dot 604. The lines that connect the directors, such as exemplary line 606, represent the companies that form the interlink between the directors. To distinguish between the different companies, different line colors, shading, or types may be used. As shown in FIG. 6, display interface 600 includes a key 608 that matches different line colors to companies for first degree and second degree interlinks. Thus, in accordance with display interface 600, the director associated with exemplary dot 604 and the query entity are both directors of the company associated with the exemplary line 606 that connects them.

In display interface 600, an interlock is represented wherever two dots are connected by two or more lines, as this indicates two directors that sit on the board of two or more of the same companies. Thus, for example, an interlock based on first degree interlinks occurs between the director associated with exemplary dot 610 and the query entity in box 602, and an interlock based on second degree interlinks occurs between the director associated with exemplary dot 604 and the director associated with exemplary dot 612.

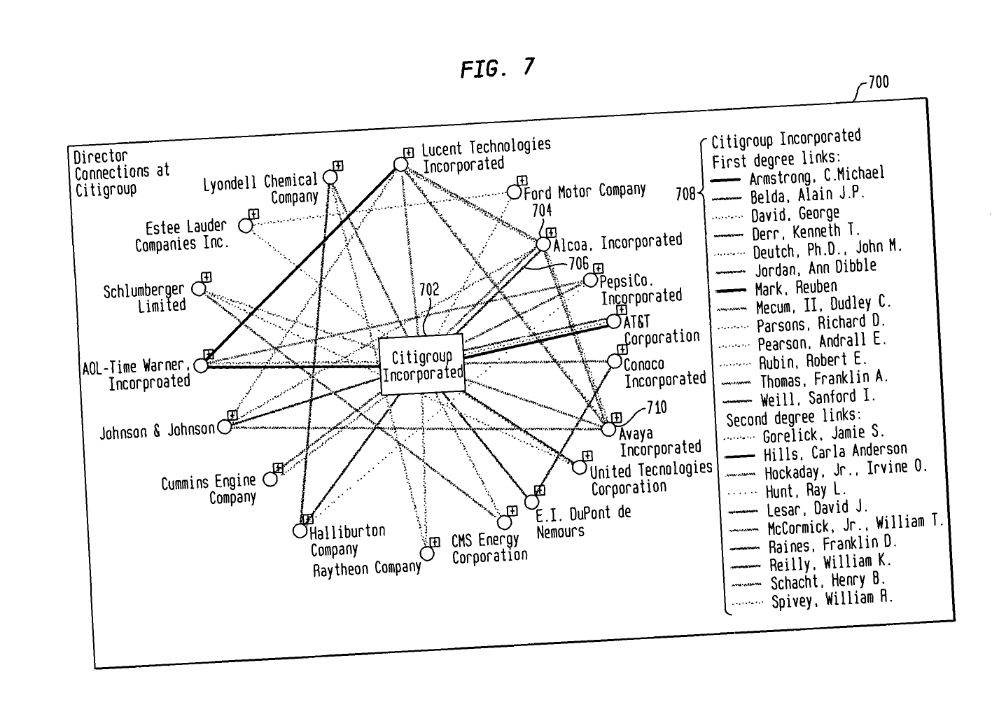

FIG. 7 illustrates an additional example display interface 700 for displaying results in a graphical format in accordance with an embodiment of the present invention. An interface such as display interface 700 may be used, for example, in an embodiment in which the query entity is a company, first degree interlinks and second degree interlinks to other companies are identified, and the interlinks are based on sharing a common director.

As shown in FIG. 7, the query entity is represented as a box 702 located near the center of the display interface 700, wherein the box 702 includes the name of the query company. Companies connected to the query company via first degree and second degree interlinks are represented as dots labeled with corresponding company names, such as exemplary dot 704. The lines that connect the companies, such as exemplary line 706, represent the directors that form the interlink between the companies. To distinguish between the different directors, different line colors, shading, or types may be used. Also, to signify certain aspects of the directorship to which the line corresponds, certain symbols may be used, such as a symbol to signify whether the director is a chief executive officer (CEO) of one of the companies that is being linked. As shown in FIG. 7, display interface 700 includes a key 708 that matches different line colors to directors for first degree and second degree interlinks. Thus, in accordance with display interface 700, the company associated with exemplary dot 704 and the query entity both employ the director associated with the exemplary line 706 that connects them.

In display interface 700, an interlock is represented wherever two dots are connected by two or more lines, as this indicates two companies that share two or more directors. Thus, for example, an interlock based on first degree interlinks occurs between the company associated with exemplary dot 704 and the query entity in box 702, and an interlock based on second degree interlinks occurs between the company associated with exemplary dot 704 and the company associated with exemplary dot 710.

In an embodiment, entities with only a single interlink either to the query entity or to another entity are not displayed in display interface 600 or display interface 700 in order to focus on only those entities with more than one interlink. This aspect also serves to further simplify viewing of the display interface. In a further embodiment, a user may also move each entity within to interface, for example by using a mouse to click and drag the dot representing the entity from one part of the interface to another, in order to enhance the clarity of the display.

In an embodiment of the invention, non-corporate affiliations between entities may also be indicated in a display interface. For example, with reference to the example display interface 700, interlinks between a corporation and a non-corporate entity, such as a non-profit, professional or academic organization, may be indicated by using a dotted line or faded line (not shown) to represent the director that is common to both organizations, wherein the color of the dotted or faded line is the same as the color of the line assigned to the director in key 708. These non-corporate interlinks represent opportunities that directors have to meet with each other in non-corporate settings, as would be indicated by memberships on charity boards, partnerships in law firms, faculty chairs in academic institutions, and the like. In accordance with an embodiment of the invention, corporate and non-corporate relationships may be shown simultaneously and may also be re-arranged within the display interface.

The display interfaces described above permit a user to easily view and understand the extensive network of influences that is created by the combination of interlinks and interlocks between directors, companies, and other organizations. By depicting the primary and secondary interlinks between directors and between companies, an embodiment of the present invention identifies relationships that may influence a director's ability to provide independent oversight on important issues including, but not limited to, CEO compensation, financial reporting, and strategic planning.

1. Additional Display Features

An additional feature of a display interface in accordance with an embodiment of the present invention includes the ability to select an entity, other than the query entity, in the display to generate a new graphic of interlinks and interlocks for the selected entity. For example with reference to display interfaces 600 and 700, by clicking on the “[+]” symbol next to a dot, a user can generate a new graphic of interlinks and interlocks for the entity represented by that dot.

Another additional feature of a display interface in accordance with an embodiment of the present invention includes the ability to access a statistics interface that provides a quantitative summary of results data generated in accordance with an embodiment of the present invention. For example, the statistics interface may provide:

An indication of how many directors and directorships are involved in the network of interlinks for a specific company or, conversely, how many companies and directorships are involved in the network of interlinks for a specific director.

A connectivity index for each entity that has a connection to the query entity, wherein the connectivity index is based on the number of interlinks that exist between the query entity and the connected entity, and wherein a higher degree of connectivity indicates a larger number of relationships. The connectivity index indicates the strength of the connections between the query entity and each of the other entities in its network of interlinks.

The sum of the pair-wise connectivity indices for a particular query entity as an overall connectivity score for that particular company or director, thereby facilitating comparisons of “connectivity,” as a measure of how embedded a company is in the hypothetical full network of all companies and directors, with other companies and directors. The overall connectivity score can be used to compare the query entity to other entities within certain peer groups. For example, for companies, the connectivity score for the query company may be compared to the connectivity score of other entities within the same index, market cap group, industry, or the like. For directors, the connectivity score for the query director may be compared to the connectivity score for other directors within the same age group or gender, to other CEOs or chairs, and the like.

Additionally, the statistics interface may also indicate aggregate data for a particular graph, including but not limited to average market cap or the board size of companies involved in a particular network.

Further additional features of a display interface in accordance with an embodiment of the present invention includes the ability to hide (in other words, not display) dead-end interlinks, wherein dead-end interlinks are defined as entities with first degree interlinks to the query entity that do not form part of a second-degree interlink, the ability to display only interlocks in the diagram, the ability to zoom in on a selected portion of the diagram, particularly where interlinks and interlocks connecting companies or directors are particularly dense, and the ability to limit the set of relationships displayed based on variables such as index membership, exchange membership, industry category, and the like.

As discussed above, a display interface in accordance with an embodiment of the present invention may display results in a tabular or list-based format. For example, such a display interface may provide a list of all the directors of a query company who sit on multiple boards, and highlight the names of companies that share two or more directors within the query company. Such a display interface may also show second degree links and interlocks. The use of a tabular or list-based display interface may be deemed desirable where the user has a low-bandwidth network connection for receiving the display interface.

2. Analysis of “Community of Values”

As discussed above, an embodiment of the present invention displays: (1) directors as nodes and corporate boards as links, or lines connecting the nodes; or (2) corporate boards as nodes and directors as links between the nodes, established by their directorships or memberships to boards of directors. In social network analysis, this type of data is known as affiliation network data: two-mode data that can be represented as a one-mode network or graph from the perspective of either the actor (e.g., a director) or the event (e.g., corporate board).

An embodiment of the invention represents implied face-to-face contact between directors via their co-membership on corporate and non-corporate boards. It implies a direct flow of information between two companies via a shared director. Consequently, these director “communications” between pairs of entities are represented by the lines, or links, joining the entities.

While direct communications can be implied via co-membership on a board of directors, it cannot necessarily be implied via, for instance, being members of the same alumni or of the same political interest group. Membership to broader groupings of individuals (such as being a member of an alumnus) that may or may not imply face-to-face communications can only be said to imply a shared formative experience or set of values. This information can be relevant in understanding, and perhaps even predicting, appointments to boards and even particular decisions made by the board. It can also reflect how homogeneous a board might be in the variety of viewpoints represented, and therefore, how much critical dissent there may be in regard to specific types of decision making.

In accordance with an embodiment of the invention, membership of a query entity, such as a director, in a group that signifies a “community of interest” is identified and displayed via the display interface. For example, the color of the various nodes displayed in the display interface may be utilized to convey this information. In accordance with such an embodiment, the user can select from a number of alternatives to view all members of a particular club, alumnus, etc. and the nodes within a visible network that belong to that grouping will be highlighted and/or change color.

E. Example Computer Implementation in Accordance with Embodiments of the Present Invention

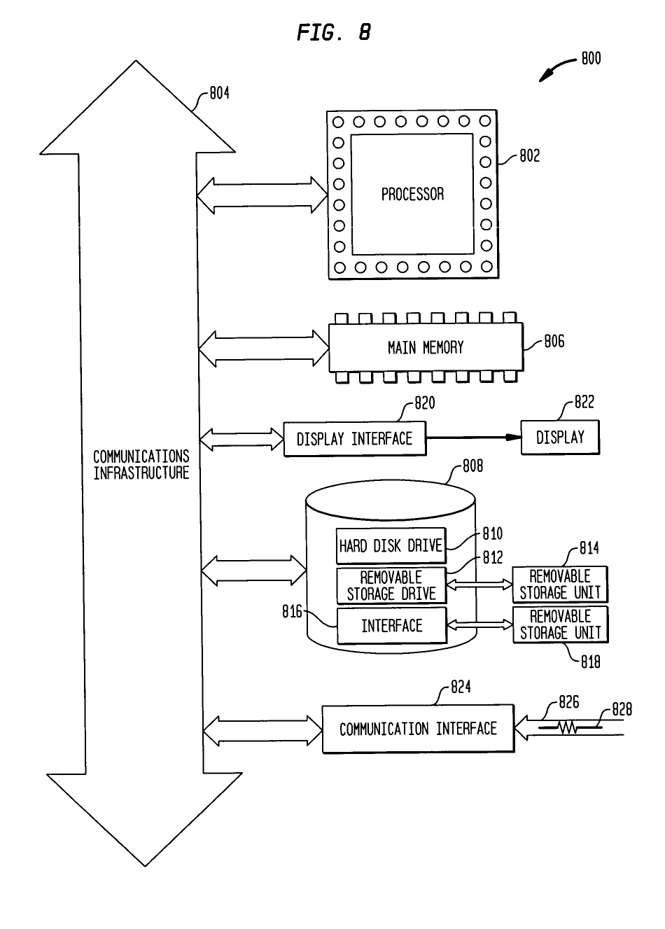

Methods for identifying and displaying inter-relationships between corporate directors and boards in accordance with embodiments of the present invention may be implemented in software and executed by one or more computer systems or other processing systems. FIG. 8 depicts an example computer system 800 that may execute software for implementing the features of the present invention, including, but not limited to, any or all of the method steps of flowchart 300 described above in reference to FIG. 3. Additionally, with reference to the software components described above in reference to FIG. 2, computer system 800 may be used to implement web browser 202, as well as one or more of web server 204, application server 206, database server 208, and/or database 210.

As shown in FIG. 8, example computer system 800 includes a processor 802 for executing software routines in accordance with embodiments of the present invention. Although a single processor is shown for the sake of clarity, computer system 800 may also comprise a multi-processor system. Processor 802 is connected to a communications infrastructure 804 for communication with other components of computer system 800. Communications infrastructure 804 may comprise, for example, a communications bus, cross-bar, or network.

Computer system 800 further includes a main memory 806, such as a random access memory (RAM), and a secondary memory 808. Secondary memory 808 may include, for example, a hard disk drive 810 and/or a removable storage drive 812, which may comprise a floppy disk drive, a magnetic tape drive, an optical disk drive, or the like. Removable storage drive 812 reads from and/or writes to a removable storage unit 814 in a well known manner. Removable storage unit 814 may comprise a floppy disk, magnetic tape, optical disk, or the like, which is read by and written to by removable storage drive 812. As will be appreciated by persons skilled in the art, removable storage unit 814 includes a computer usable storage medium having stored therein computer software and/or data.

In alternative embodiments, secondary memory 808 may include other similar means for allowing computer programs or other instructions to be loaded into computer system 800. Such means can include, for example, a removable storage unit 818 and an interface 816. Examples of a removable storage unit 818 and interface 816 include a program cartridge and cartridge interface (such as that found in video game console devices), a removable memory chip (such as an EPROM, or PROM) and associated socket, and other removable storage units 818 and interfaces 816 that allow software and data to be transferred from removable storage unit 818 to computer system 800.

Computer system 800 further includes a display interface 820 that forwards graphics, text, and other data from communications infrastructure 804 or from a frame buffer (not shown) for display to a user on a display unit 822.

Computer system 800 also includes a communication interface 824. Communication interface 824 allows software and data to be transferred between computer system 800 and external devices via a communication path 826. Examples of communication interface 824 include a modem, a network interface (such as Ethernet card), a communication port, and the like. Software and data transferred via communication interface 824 are in the form of signals 828 which can be electronic, electromagnetic, optical or other signals capable of being received by communication interface 824. These signals 828 are provided to communication interface 824 via communication path 826.

As used herein, the term “computer program product” may refer, in part, to removable storage unit 814, removable storage unit 818, a hard disk installed in hard disk drive 810, or a carrier wave carrying software over communication path 826 (wireless link or cable) to communication interface 824. A computer useable medium can include magnetic media, optical media, or other recordable media, or media that transmits a carrier wave or other signal. These computer program products are means for providing software to computer system 800.

Computer programs (also called computer control logic) are stored in main memory 806 and/or secondary memory 808. Computer programs can also be received via communication interface 824. Such computer programs, when executed, enable computer system 800 to perform the features of the present invention as discussed herein. In particular, the computer programs, when executed, enable processor 802 to perform the features of the present invention. Accordingly, such computer programs represent controllers of the computer system 800.

In an embodiment where the present invention is implemented using software, the software may be stored in a computer program product and loaded into computer system 800 using removable storage drive 812, hard disk drive 810 or communication interface 824. Alternatively, the computer program product may be downloaded to computer system 800 over communication path 826. The software, when executed by processor 802, causes processor 802 to perform features of the invention as described herein.

F. Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims.

For example, methods in accordance with the present invention need not be carried out over a network environment such as that depicted in FIG. 1, but may also be carried out using a single computer system, wherein the computer system provides at least an interface for accepting user input and displaying results and an application program for accessing a database and generating results based on the user input.

Furthermore, the present invention encompasses business methods that include receiving payment in exchange for generating interlink and interlock information relating to a query entity, wherein the payment can comprise a one-time fee or a subscription fee for services of a specific type and/or duration. Such transactions can occur over a network, such as the Internet, and methods for processing such transactions are well-known in the art.

In light of the foregoing, the breadth and scope of the present invention should not be limited by any of the above-described exemplary embodiments, but should be defined only in accordance with the following claims and their equivalents.

What is claimed is:

1. A computer program product comprising a computer useable medium having computer program logic recorded thereon for enabling a processor in a computer system to identify and display inter-relationships between corporate directors, said computer program logic comprising:
first means for enabling the processor to select a query director;
second means for enabling the processor to search a database to identify corporations having a board of directors upon which said query director sits;
third means for enabling the processor to search said database to identify a first group of directors, wherein each director in said first group of directors sits on a board of one or more of said corporations identified by said second means;
fourth means for enabling the processor to identify a second group of directors from said first group of directors, wherein each director in said second group of directors sits on a board of two or more of said corporations identified by said second means; and
fifth means for enabling the processor to display results generated by said third means and said fourth means.

2. The computer program product of claim 1, wherein said first means comprises means for enabling the processor to select a query director based on input provided via a user interface.

3. The computer program product of claim 2, wherein said means for enabling the processor to select a query director based on input provided via a user interface comprises means for enabling the processor to select a query director based on input provided over a network via a web interface.

4. The computer program product of claim 1, wherein said second and third means comprise means for enabling the processor to search a relational database using Structured Query Language (SQL).

5. The computer program product of claim 1, wherein said fifth means comprises means for enabling the processor to display results generated by said third means and said fourth means in a graphical format.

6. The computer program product of claim 1, wherein said fifth means comprises means for enabling the processor to display results generated by said third means and said fourth means in a tabular format.

7. The computer program product of claim 1, wherein said fifth means comprises means for enabling the processor to transmit results generated by said third means and said fourth means over a network for display via a web interface.

8. The computer program product of claim 1, further comprising:
means for enabling the processor to store results generated by said third means and said fourth means.

9. The computer program product of claim 1, further comprising:
sixth means for enabling the processor to search said database to identify corporations having a board of directors upon which a selected director from said first group of directors sits;
seventh means for enabling the processor to search said database to identify a third group of directors, wherein each director in said third group of directors sits on a board of one or more of said corporations identified by said sixth means;
eighth means for enabling the processor to identify a fourth group of directors from said third group of directors, wherein each director in said fourth group of directors sits on a board of two or more of said corporations identified by said sixth means; and
ninth means for displaying results generated by said seventh and eighth means.

10. The computer program product of claim 1, further comprising:
sixth means for enabling the processor to search said database to identify non-corporate entities with which said query director is affiliated;
seventh means for enabling the processor to search said database to identify a third group of directors, wherein each director in said third group of directors is affiliated with one or more of said non-corporate entities identified by said sixth means;
eighth means for enabling the processor to identify a fourth group of directors from said third group of directors, wherein each director in said fourth group of directors is affiliated with two or more of said non-corporate entities identified by said sixth means; and
ninth means for enabling the processor to display results generated by said seventh and eighth means.

11. A computer program product comprising a computer useable medium having computer program logic recorded thereon for enabling a processor in a computer system to identify and display inter-relationships between corporations, said computer program logic comprising:
first means for enabling the processor to select a query corporation;
second means for enabling the processor to search a database to identify directors that sit on a board of directors of said query corporation;
third means for enabling the processor to search said database to identify a first group of corporations, wherein each corporation in said first group of corporations has a board of directors that includes one or more of said directors identified by said second means;
fourth means for enabling the processor to identify a second group of corporations from said first group of corporations, wherein each corporation in said second group of corporations has a board of directors that includes two or more of said directors identified by said second means; and
fifth means for enabling the processor to display results generated by said third means and said fourth means.

12. The computer program product of claim 11, wherein said first means comprises means for enabling the processor to select a query corporation based on input provided via a user interface.

13. The computer program product of claim 12, wherein said means for enabling the processor to select a query corporation based on input provided via a user interface comprises means for enabling the processor to select a query corporation based on input provided over a network via a web interface.

14. The computer program product of claim 11, wherein said second and third means comprise means for enabling the processor to search a relational database using Structured Query Language (SQL).

15. The computer program product of claim 11, wherein said fifth means comprises means for enabling the processor to display results generated by said third means and said fourth means in a graphical format.

16. The computer program product of claim 11, wherein said fifth means comprises means for enabling the processor to display results generated by said third means and said fourth means in a tabular format.

17. The computer program product of claim 11, wherein said fifth means comprises means for enabling the processor to transmit results generated by said third means and said fourth means over a network for display via a web interface.

18. The computer program product of claim 11, further comprising:
means for enabling the processor to store results generated by said third means and said fourth means.

19. The computer program product of claim 11, further comprising:
sixth means for enabling the processor to search said database to identify directors that sit on a board of directors of a selected corporation from said first group of corporations;
seventh means for enabling the processor to search said database to identify a third group of corporations, wherein each corporation in said third group of corporations has a board of directors that includes one or more of said directors identified by said sixth means;
eighth means for enabling the processor to identify a fourth group of corporations from said third group of corporations, wherein each corporation in said fourth group of corporations has a board of directors that includes two or more of said directors identified by said sixth means; and
means for enabling the processor to display results generated by said seventh means and said eighth means.

20. The computer program product of claim 11, further comprising:
sixth means for enabling the processor to search said database to identify a first group of non-corporate entities, wherein each entity in said first group of non-corporate entities is affiliated with one or more of said directors identified by said second means;
seventh means for enabling the processor to search said database to identify a second group of non-corporate entities, wherein each entity in said second group of non-corporate entities is affiliated with two or more of said directors identified by said second means; and
eighth means for displaying results generated by said sixth means and said seventh means.

21. A method for identifying and displaying inter-relationships between corporate directors, comprising:
(a) selecting a query director;
(b) searching a database to identify corporations having a board of directors upon which said query director sits;
(c) searching said database to identify a first group of directors, wherein each director in said first group of directors sits on a board of one or more of said corporations identified in step (b);
(d) identifying a second group of directors from said first group of directors, wherein each director in said second group of directors sits on a board of two or more of said corporations identified in step (b); and
(e) displaying results from steps (c) and (d).

22. The method of claim 21, wherein step (a) comprises selecting a query director based on input provided via a user interface.

23. The method of claim 22, wherein selecting a query director based on input provided via a user interface comprises selecting a query director based on input provided over a network via a web interface.

24. The method of claim 21, wherein searching said database comprises searching a relational database using Structured Query Language (SQL).

25. The method of claim 21, wherein step (e) comprises displaying results from steps (c) and (d) in a graphical format.

26. The method of claim 21, wherein step (e) comprises displaying results from steps (c) and (d) in a tabular format.

27. The method of claim 21, wherein step (e) comprises transmitting results from steps (c) and (d) over a network for display via a web interface.

28. The method of claim 21, further comprising:
storing said results from steps (c) and (d) prior to performing step (e).

29. The method of claim 21, further comprising:
(f) searching said database to identify corporations having a board of directors upon which a selected director from said first group of directors sits;
(g) searching said database to identify a third group of directors, wherein each director in said third group of directors sits on a board of one or more of said corporations identified in step (f);
(h) identifying a fourth group of directors from said third group of directors, wherein each director in said fourth group of directors sits on a board of two or more of said corporations identified in step (f); and
(i) displaying results from steps (g) and (h).

30. The method of claim 21, further comprising:
(f) searching said database to identify non-corporate entities with which said query director is affiliated;
(g) searching said database to identify a third group of directors, wherein each director in said third group of directors is affiliated with one or more of said non-corporate entities identified in step (f);
(h) identifying a fourth group of directors from said third group of directors, wherein each director in said fourth group of directors is affiliated with two or more of said non-corporate entities identified in step (f); and
(i) displaying results from steps (g) and (h).

31. A method for identifying and displaying inter-relationships between corporations, comprising:
(a) selecting a query corporation;
(b) searching a database to identify directors that sit on a board of directors of said query corporation;
(c) searching said database to identify a first group of corporations, wherein each corporation in said first group of corporations has a board of directors that includes one or more of said directors identified in step (b);
(d) identifying a second group of corporations from said first group of corporations, wherein each corporation in said second group of corporations has a board of directors that includes two or more of said directors identified in step (b); and
(e) displaying results from steps (c) and (d).

32. The method of claim 31, wherein step (a) comprises selecting a query corporation based on input provided via a user interface.

33. The method of claim 32, wherein selecting a query corporation based on input provided via a user interface comprises selecting a query corporation based on input provided over a network via a web interface.

34. The method of claim 31, wherein searching said database comprises searching a relational database using Structured Query Language (SQL).

35. The method of claim 31, wherein step (e) comprises displaying results from steps (c) and (d) in a graphical format.

36. The method of claim 31, wherein step (e) comprises displaying results from steps (c) and (d) in a tabular format.

37. The method of claim 31, wherein step (e) comprises transmitting results from steps (c) and (d) over a network for display via a web interface.

38. The method of claim 31, further comprising:
storing said results from steps (c) and (d) prior to performing step (e).

39. The method of claim 31, further comprising:
(f) searching said database to identify directors that sit on a board of directors of a selected corporation from said first group of corporations;
(g) searching said database to identify a third group of corporations, wherein each corporation in said third group of corporations has a board of directors that includes one or more of said directors identified in step (f);
(h) identifying a fourth group of corporations from said third group of corporations, wherein each corporation in said fourth group of corporations has a board of directors that includes two or more of said directors identified in step (f); and
(i) displaying results from steps (g) and (h).

40. The method of claim 31, further comprising:
(f) searching said database to identify a first group of non-corporate entities, wherein each entity in said first group of non-corporate entities is affiliated with one or more of said directors identified in step (b);
(g) searching said database to identify a second group of non-corporate entities, wherein each entity in said second group of non-corporate entities is affiliated with two or more of said directors identified in step (b); and
(h) displaying results from steps (f) and (g).
